(19) United States
(12) Patent Application Publication
(10) Pub. No.: US 2026/0141215 A1
(43) Pub. Date: May 21, 2026

(54) METHOD AND ELECTRONIC DEVICE FOR PREDICTING ATOMIC FORCE USING GNN AND 3D BUCKET QUEUE MODELS

(71) Applicant: SAMSUNG ELECTRONICS CO., LTD., SUWON-SI, GYEONGGI-DO (KR)

(72) Inventors: Zhen Zhang, Xi’an (CN); Jiali Pang, Xi’an (CN); Lin CHEN, Xi’an (CN); IHOR VASYLTSOV, Suwon-si (KR)

(21) Appl. No.: 19/307,528

(22) Filed: Aug. 22, 2025

(30) Foreign Application Priority Data
Nov. 20, 2024 (CN) 202411663068.8
Apr. 1, 2025 (KR) 10-2025-0042154

(51) Int. Cl. G06N 3/042

(52) U.S. Cl. CPC G06N 3/042

(57) ABSTRACT

A method and electronic device for predicting an atomic force are provided. The method includes obtaining atomic position data representing a molecular system, performing, using a graph neural network (GNN) model, a first simulation on the atomic position data to generate a plurality of atomic forces, updating parameters of a three-dimensional (3D) bucket queue model based on the plurality of atomic forces, wherein the 3D bucket queue model is configured to predict an atomic force of a subsequent simulation based on an atomic force of a prior simulation, and generating, using the updated 3D bucket queue model, a second plurality of atomic forces by performing a second simulation.

### CROSS-REFERENCE TO RELATED APPLICATIONS

This U.S non-provisional patent application claims priority under 35 U.S.C. § 119 to Chinese Patent Application No. 202411663068.8, filed on Nov. 20, 2024, in the China National Intellectual Property Administration, and Korean Patent Application No. 10-2025-0042154 filed on Apr. 1, 2025, in the Korean Intellectual Property Office, the disclosures of which are incorporated by reference herein in its entirety.

### TECHNICAL FIELD

The following description relates to a molecular dynamics simulation field, and more particularly, to a method and electronic device for predicting an atomic force.

### DISCUSSION OF RELATED ART

Molecular dynamics is a computational material science methodology used to simulate the atomic motion of a material system under realistic operating pressure and temperature conditions. Conventional molecular dynamics simulation computes atomic force and potential energy of the material system by using a graph neural network (GNN) model to enhance accuracy.

In some cases, for example, the molecular dynamics simulation speed can be enhanced by performing the simulation by using a lightweight GNN model. However, using a lightweight GNN model reduces the accuracy of the lightweight GNN model, and thus the accuracy of the overall simulation is degraded.

Accordingly, a method and a system for maintaining the original accuracy of a GNN model while effectively enhancing the molecular dynamics simulation speed may be needed.

### SUMMARY

A method and electronic device for predicting an atomic force. The method may maintain the accuracy of an original graph neural network (GNN) model while at least enhancing the molecular dynamics simulation speed.

According to an embodiment, a method, performed by an electronic device, of predicting an atomic force may include obtaining atomic position data representing a molecular system, performing, using a graph neural network (GNN) model, a first simulation on the atomic position data to generate a plurality of atomic forces, updating parameters of a three-dimensional (3D) bucket queue model based on the plurality of atomic forces, where the 3D bucket queue model is configured to predict an atomic force of a subsequent simulation based on an atomic force of a prior simulation, and generating, using the updated 3D bucket queue model, a second plurality of atomic forces by performing a second simulation. In one aspect, the first simulation may include obtaining a first number of atomic forces for each atom by performing the first simulation for a first predetermined number of repetitions of a first type. The second simulation may include obtaining a second number of atomic forces for each atom by performing the second simulation for a second predetermined number of repetitions of a second type.

The electronic device may improve the molecular dynamics simulation speed by reducing a simulation count using the GNN model by performing the simulation using the 3D bucket queue model that may predict a current atomic force from a previous atomic force. The electronic device may prevent the accuracy of the simulation using the 3D bucket queue model from degrading and may maintain the accuracy of an original GNN model by updating the 3D bucket queue model based on a simulation result using the GNN model.

The method may further include iteratively performing the first simulation and the second simulation until a number of repetitions of the second type reaches a predetermined threshold value.

The electronic device may adjust the balance between the simulation performance and the accuracy by controlling a count of simulations using the 3D bucket queue model through a predetermined threshold value and a second number. The electronic device may prevent the accuracy of atomic force prediction using the 3D bucket queue model from degrading over time by alternately executing the first simulation and the second simulation and using a result of the first simulation as online learning training data of the 3D bucket queue model.

The iteratively executing of the first simulation and the second simulation may include iteratively performing the first simulation and the second simulation when at least one of the first predetermined number of repetitions or the second predetermined number of repetitions is changed.

The method may further include performing, using the GNN model, a third simulation to obtain a preliminary result, and initializing the 3D bucket queue model based on the preliminary result. The third simulation may include obtaining a third number of atomic forces for each atom by performing the third simulation for a third predetermined number of repetitions of the first type.

The electronic device may improve the accuracy of the simulation using the 3D bucket queue model by initializing the 3D bucket queue model using a result of the third simulation before executing the simulation using the 3D bucket queue model.

The executing of the third simulation may include, when a simulation of the first type is performed for the first time within the third simulation, generating, using the GNN model, atomic potential energy based on an initial atomic position of the atomic position data, and generating an atomic force based on the atomic potential energy. When a simulation of the first type is not performed for the first time within the third simulation, updating an atomic speed based on an atomic force from the prior simulation, updating an atomic position based on the updated atomic speed, generating, using the GNN model, atomic potential energy based on the updated atomic position, and generating an atomic force based on the atomic potential energy.

The 3D bucket queue model includes a plurality of buckets divided within a predetermined atomic force space and a plurality of queues corresponding to the plurality of buckets, respectively. The atomic force space includes a first atomic force range on a first coordinate axis, a second atomic force range on a second coordinate axis, and a third atomic force range on a third coordinate axis. The plurality of buckets is generated by dividing the first atomic force range into a first plurality of arrays at a first interval, dividing the second atomic force range into a second plurality of arrays at a second interval, and dividing the third atomic force range into a third plurality of arrays at a third interval. A queue corresponding to each bucket includes a subsequent bucket to which a subsequent atomic force following an atomic force corresponding to the bucket, and includes a weight indicating a probability of an appearance of the subsequent bucket.

The updating of the 3D bucket queue model may include, for each of the first predetermined number of repetitions of the first type, storing a previous atomic force obtained from a previous simulation before performing the simulation of the first type and mapping the previous atomic force to a first 3D bucket within the plurality of buckets, mapping an atomic force from the simulation of the first type to a second 3D bucket within the plurality of buckets, determining whether the second 3D bucket is included in a queue of the first 3D bucket, increasing a weight of the second 3D bucket by a first value when the second 3D bucket is included in the queue of the first 3D bucket, and adding the second 3D bucket to the queue of the first 3D bucket and setting the weight of the second 3D bucket to a default value.

The executing of the simulation of the second type may include, for each of the second predetermined number of repetitions of the second type, mapping a previous atomic force from a previous simulation, before performing the simulation of the second type, to a third 3D bucket within the plurality of buckets, obtaining a bucket having a maximum weight in a queue of the third 3D bucket, and generating a predicted atomic force based on the bucket having the maximum weight.

The mapping of the previous atomic force to the third 3D bucket of the plurality of buckets may include determining an index of the previous atomic force based on a first component corresponding to a first coordinate axis of the previous atomic force from a first array of the first plurality of arrays, a second component corresponding to a second coordinate axis of the previous atomic force from a second array of the second plurality of arrays, and a third component corresponding to a third coordinate axis of the previous atomic force from a third array of the third plurality of arrays, and determining the third 3D bucket based on the index of the previous atomic force.

The predicted atomic force includes the bucket having the maximum weight.

According to an embodiment, an electronic device may include a processor, and a memory storing one or more instructions, wherein the one or more instructions, when executed by the processor, may cause the electronic device to obtain atomic position data representing a molecular system, perform, using a graph neural network (GNN) model, a first simulation on the atomic position data to generate a plurality of atomic forces, update parameters of a three-dimensional (3D) bucket queue model based on the plurality of atomic forces, where the 3D bucket queue model is configured to predict an atomic force of a subsequent simulation based on an atomic force of a prior simulation, and generate, using the updated 3D bucket queue model, a second plurality of atomic forces by performing a second simulation.

The electronic device may improve the molecular dynamics simulation speed by reducing a simulation count using the GNN model by performing the simulation using the 3D bucket queue model that may predict a current atomic force from a previous atomic force. The electronic device may prevent the accuracy of the simulation using the 3D bucket queue model from degrading and may maintain the accuracy of an original GNN model by updating the 3D bucket queue model based on a simulation result using the GNN model.

The one or more instructions, when executed by the processor, may cause the electronic device to iteratively perform the first simulation and the second simulation until a number of repetitions of the second type reaches a predetermined threshold value.

The electronic device may adjust the balance between the simulation performance and the accuracy by controlling a count of simulations using the 3D bucket queue model through a predetermined threshold value and a second number. The electronic device may prevent the accuracy of atomic force prediction using the 3D bucket queue model from degrading over time by alternately executing the first simulation and the second simulation and using a result of the first simulation as online learning training data of the 3D bucket queue model.

The one or more instructions, when executed by the processor, may cause the electronic device to iteratively perform the first simulation and the second simulation when at least one of the first predetermined number of repetitions or the second predetermined number of repetitions is changed.

The one or more instructions, when executed by the processor, may cause the electronic device to perform, using the GNN model, a third simulation to obtain a preliminary result, and initializing the 3D bucket queue model based on the preliminary result. The third simulation may include obtaining a third number of atomic forces for each atom by performing the third simulation for a third predetermined number of repetitions of the first type.

The electronic device may improve the accuracy of the simulation using the 3D bucket queue model by initializing the 3D bucket queue model using a result of the third simulation before executing the simulation using the 3D bucket queue model.

The one or more instructions, when executed by the processor, may cause the electronic device to, when a simulation of the first type is performed for the first time within the third simulation, generating, using the GNN model, atomic potential energy based on an initial atomic position of the atomic position data, and generating an atomic force based on the atomic potential energy. When a simulation of the first type is not performed for the first time within the third simulation, updating an atomic speed based on an atomic force from the prior simulation, updating an atomic position based on the updated atomic speed, generating, using the GNN model, atomic potential energy based on the updated atomic position, and generating an atomic force based on the atomic potential energy.

The 3D bucket queue model includes a plurality of buckets divided within a predetermined atomic force space and a plurality of queues corresponding to the plurality of buckets, respectively. The atomic force space includes a first atomic force range on a first coordinate axis, a second atomic force range on a second coordinate axis, and a third atomic force range on a third coordinate axis. The plurality of buckets is generated by dividing the first atomic force range into a first plurality of arrays at a first interval, dividing the second atomic force range into a second plurality of arrays at a second interval, and dividing the third atomic force range into a third plurality of arrays at a third interval. A queue corresponding to each bucket includes a subsequent bucket to which a subsequent atomic force following an atomic force corresponding to the bucket, and includes a weight indicating a probability of an appearance of the subsequent bucket.

The one or more instructions, when executed by the processor, may cause the electronic device to, for each of the first predetermined number of repetitions of the first type, storing a previous atomic force obtained from a previous simulation before performing the simulation of the first type and mapping the previous atomic force to a first 3D bucket within the plurality of buckets, mapping an atomic force from the simulation of the first type to a second 3D bucket within the plurality of buckets, determining whether the second 3D bucket is included in a queue of the first 3D bucket, increasing a weight of the second 3D bucket by a first value when the second 3D bucket is included in the queue of the first 3D bucket, and adding the second 3D bucket to the queue of the first 3D bucket and setting the weight of the second 3D bucket to a default value.

The one or more instructions, when executed by the processor, may cause the electronic device to, for each of the second predetermined number of repetitions of the second type, mapping a previous atomic force from a previous simulation, before performing the simulation of the second type, to a third 3D bucket within the plurality of buckets, obtaining a bucket having a maximum weight in a queue of the third 3D bucket, and generating a predicted atomic force based on the bucket having the maximum weight.

The one or more instructions, when executed by the processor, may cause the electronic device to determine an index of the previous atomic force based on a first component corresponding to a first coordinate axis of the previous atomic force from a first array of the first plurality of arrays, a second component corresponding to a second coordinate axis of the previous atomic force from a second array of the second plurality of arrays, and a third component corresponding to a third coordinate axis of the previous atomic force from a third array of the third plurality of arrays, and determining the third 3D bucket based on the index of the previous atomic force.

The predicted atomic force includes the bucket having the maximum weight.

According to an embodiment, a non-transitory computer-readable storage medium may store one or more instructions, and the one or more instructions, when executed by a processor, may implement the above described method.

Other features and aspects may be apparent from the following detailed description, the drawings, and the claims.

### BRIEF DESCRIPTION OF THE DRAWINGS

FIG. 1 is a flowchart of a method for predicting an atomic force, according to an embodiment.

FIG. 2 is a flowchart of a process for performing a first simulation, according to an embodiment.

FIGS. 3A and 3B are an example of a three-dimensional (3D) bucket queue model, according to an embodiment.

FIG. 4A is an example of a process for initializing and updating a 3D bucket queue model, according to an embodiment.

FIG. 4B is a flowchart of a process for initializing and updating a 3D bucket queue model, according to an embodiment.

FIG. 5 is a flowchart of a process of performing a second simulation, according to an embodiment.

FIG. 6 is a flowchart of a method for predicting an atomic force, according to an embodiment.

FIG. 7 is a block diagram of an electronic device according to an embodiment.

FIG. 8 is a block diagram of an electronic device according to an embodiment.

FIG. 9 is a flowchart of a method for predicting an atomic force, according to an embodiment.

### DETAILED DESCRIPTION

The following detailed description is provided as an example and various alterations and/or modifications may be made to the embodiments. Accordingly, the embodiments are not construed as limited to the disclosure and should be understood to include various changes, modifications, and equivalents of the described method, device, and/or system. For example, the order of described operations is described as an example and is not necessarily limited to the described order, but the order may be changed as it is clear after understanding the description other than the operation to be performed in a specific order.

The described features may be implemented in different forms and are not necessarily limited to the described embodiments. Conversely, the described examples are provided to describe various possible methods of implementing the described method, device, and/or system.

Any structural or functional description of the described example below is for describing an example, and the example may be implemented in various forms. The example is not necessarily intended to limit the scope of this invention, and intends to include various modifications, equivalents, and alternatives in the scope of claims.

Although terms, such as “first” or “second”, are used to describe various elements, the elements are not necessarily limited by the terms. These terms are used to distinguish an element from another element. Accordingly, the “first” element may be referred to as the “second” element, or similarly, the “second” element may be referred to as the “first” element.

When the element is “coupled” to another element, it represents that the element may be directly connected or coupled to the other element or other components may exist therebetween.

The singular forms are intended to include the plural forms as well, unless the context clearly indicates otherwise. For example, the terms, “a”, “an”, or “the” may include one or more of the described elements. The terms “comprises,” “includes,” and “has” describe the presence of stated features, numbers, operations, components, elements, and/or combinations thereof, but do not preclude the presence or addition of one or more other features, numbers, operations, components, elements, and/or combinations thereof.

Unless otherwise defined, all terms (including technical and scientific terms) used herein have the same meaning as commonly understood by one of ordinary skill in the art to which this disclosure pertains. Unless explicitly defined, terms (e.g., terms defined in commonly-used dictionaries) should be interpreted as having a meaning that is consistent with their meaning in the context of the relevant art and will not be interpreted in an idealized or overly formal sense.

Hereinafter, examples are described in detail with reference to the drawings. It should be noted that for the reference numerals of the components in the drawings, like reference numerals refer to like components. To the extent that an element is not described in detail with respect to a figure, it may be understood that the element is at least similar to a corresponding element that has been described elsewhere within the present disclosure. The shapes, sizes, ratios, angles, numbers, etc. disclosed in the drawings for explaining the embodiments are exemplary, and therefore the present invention is not necessarily limited to the matters illustrated.

Embodiments of the inventive concept provide a method and system for predicting atomic forces in molecular dynamics simulations using a network that combines a graph neural network (GNN) model and a three-dimensional (3D) bucket queue model. The GNN model generates high-accuracy atomic force vectors based on atomic position data. The 3D bucket queue model is configured to predict atomic forces of a subsequent simulation based on atomic forces of a prior simulation. The 3D bucket queue model discretizes the atomic force space into a plurality of buckets across three coordinate axes and stores transition probabilities between buckets using weighted queues. Atomic forces predicted from the queue model can be generated without performing a GNN inference, thereby reducing computational load.

In some embodiments, the 3D bucket queue model is initialized using results from an initial set of GNN-based simulations and is dynamically updated over time using data obtained from the first-type simulations. The method includes alternating first-type and second-type simulations, enabling the system to maintain accuracy while leveraging the efficiency of the bucket queue model. The model architecture reduces reliance on the GNN for every timestep while preserving the accuracy of the prediction for the atomic forces.

Embodiments of the inventive concept provide a technical improvement in the field of molecular dynamics simulations by reducing the computational cost (e.g., computing power, time, etc.) associated with high-fidelity force prediction models such as graph neural networks (GNNs). Conventional GNN-based simulations, while accurate, require substantial computational costs when used at each simulation timestep. The present method addresses this limitation by introducing a learned, discretized 3D bucket queue model that efficiently predicts atomic forces based on prior simulation results. By alternating between GNN-based and queue-based simulations, embodiments of the present disclosure can generate comparable force prediction accuracy with fewer GNN processes. The combination of the GNN model and the 3D bucket queue model reduces latency, lowers hardware resource demands, and enables faster simulation of complex molecular systems.

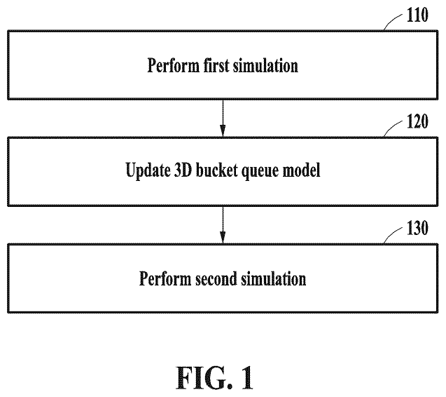

FIG. 1 is a flowchart of a method for predicting an atomic force, according to an embodiment.

As shown in FIG. 1, in operation 110, an electronic device may perform a first simulation based on a graph neural network (GNN) model.

According to an embodiment, the first simulation may include obtaining a first number of atomic forces for each atom by performing a first simulation for a first predetermined number of iterations.

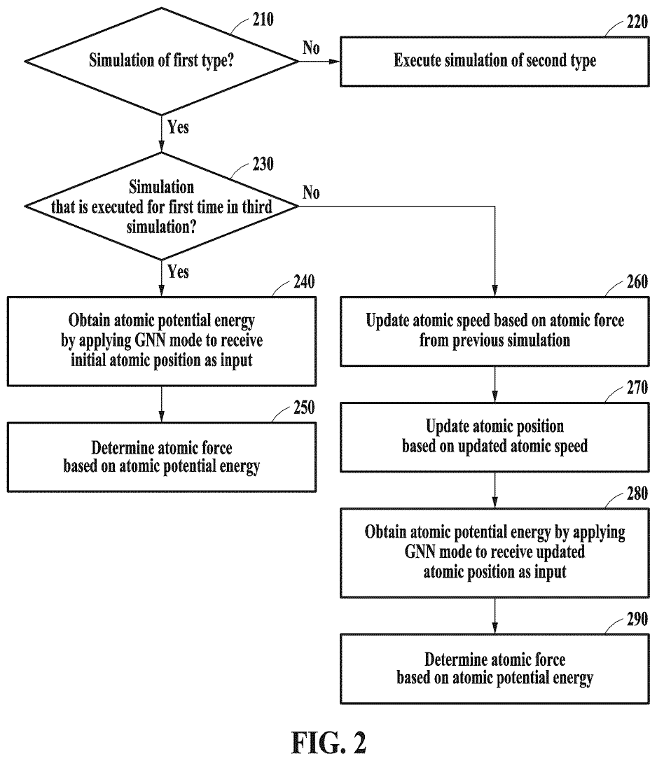

For example, the first simulation may include a simulation for predicting an atomic force based on a GNN model. Various known GNN models can be applied, and the models used for the method for predicting an atomic force are not necessarily limited thereto. Further detail on the process for performing the first simulation is further described with reference to FIG. 2.

In operation 120, the electronic device may update a three-dimensional (3D) bucket queue model based on a result obtained from the first simulation.

In an embodiment, unlike a GNN model that predicts an atomic force based on an atomic position, the 3D bucket queue model may predict the atomic force for a current simulation using the atomic force obtained from a previous simulation. For example, the 3D bucket queue model may predict an atomic force of an i+1-th simulation based on an atomic force of an i-th simulation (i may be a natural number greater than or equal to 1).

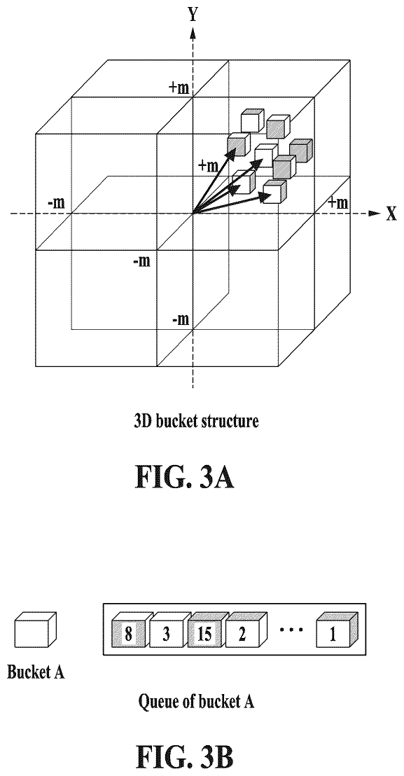

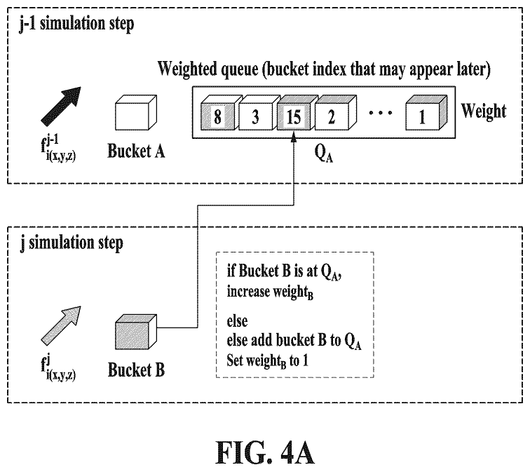

Further detail on the 3D bucket queue model is described with reference to FIGS. 3A and 3B, and a process of updating the 3D bucket queue model is described with reference to FIGS. 4A and 4B.

In operation 130, the electronic device may perform a second simulation based on the updated 3D bucket queue model.

According to an embodiment, the second simulation may include obtaining a second number of atomic forces for each atom by performing a second simulation for a second predetermined number of iterations.

For example, the second simulation may include a simulation for predicting an atomic force based on the 3D bucket queue model.

In an embodiment, when the immediately preceding simulation is of the first simulation (or of the first type), the atomic force may be predicted based on the result of the simulation of the first type using the 3D bucket queue model. Conversely, when the immediately preceding simulation is of the second simulation (or the second type), the atomic force may be predicted based on the result of the previous second-type simulation using the 3D bucket queue model.

In an embodiment, the first predetermined number of iterations may be greater than the second predetermined number of iterations. However, the example is not necessarily limited thereto, and the first predetermined number of iterations may be less than or equal to the second predetermined number of iterations.

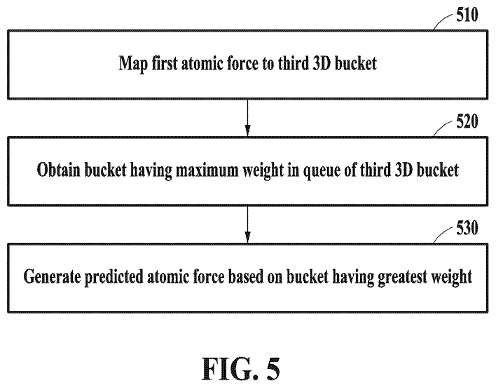

Further detail on the simulation of the second type (or the second simulation) is described with reference to FIG. 6.

According to an embodiment, the method may include iteratively performing the first simulation and the second simulation until a number of the second-type simulation reaches a predetermined threshold value.

In an embodiment, the electronic device may prevent the accuracy from degrading over time by alternately performing the first simulation and the second simulation.

In an embodiment, the first predetermined number of iterations corresponding to the first simulation and the second predetermined number of iterations corresponding to the second simulation may remain constant. In an embodiment, when at least one of the first predetermined number of iterations and the second predetermined number of iterations is varied, the electronic device may iteratively perform the first simulation and the second simulation.

According to an embodiment, the method may further include, before initially performing the first simulation, performing a third simulation based on the GNN model and initializing the 3D bucket queue model based on a result obtained from the third simulation.

According to an embodiment, the third simulation may include obtaining a third number of atomic forces for each atom by performing the first simulation (e.g., a simulation of the first type) for a third predetermined number of iterations. In an embodiment, the third predetermined number of iterations may be greater than the first predetermined number of iterations.

Further detail on the process of initializing the 3D bucket queue model is described with reference to FIGS. 4A and 4B.

The electronic device may enhance the molecular dynamics simulation speed by decreasing the number of simulations performed with the GNN model and instead performing simulations with the 3D bucket queue model, which may predict a current atomic force from a previous atomic force. The electronic device may update the 3D bucket queue model based on the simulation result obtained from the GNN model to prevent degradation in prediction accuracy and to maintain the accuracy of the original GNN model.

The electronic device may adjust the balance between the simulation performance and the accuracy by controlling the number of simulations performed with the 3D bucket queue model based on the predefined threshold value and the second predetermined number of iterations. The electronic device may alternately perform the first simulation and the second simulation and may use the result of the first simulation as online learning training data for the 3D bucket queue model. Accordingly, the electronic device may prevent the degradation of the accuracy of the atomic force prediction using the 3D bucket queue model.

In some embodiments, the first predetermined number of iterations may be selected to provide training data for the 3D bucket queue model. The second predetermined number of iterations may be configured to reduce reliance on the GNN model while maintaining the atomic force prediction accuracy. These values may be selected based on the specific molecular system being simulated.

In some aspects, the GNN model may receive an atomic graph as input that encodes the spatial and/or chemical relationships between atoms in a molecular system. Each node in the graph may represent an atom, with node features including atomic type, valence, and other descriptors. Edges may represent interatomic distances, bond types, or force interactions, and may include distance-based weighting. The GNN model may output atomic potential energy values or atomic force vectors as a function of atomic positions. In some cases, atomic forces are obtained by computing the gradient of the predicted potential energy with respect to atomic positions.

FIG. 2 is a flowchart of a process for performing a first simulation, according to an embodiment. In some cases, FIG. 2 depicts a process for performing a simulation of a first type.

As shown in FIG. 2, in operation 210, an electronic device may determine whether a simulation is of a first type.

When the electronic device determines that the simulation to be performed is not of the first type, then in operation 220, the electronic device may perform a simulation of a second type (or a second simulation).

When the electronic device determines that the simulation to be performed is of the first type, then in operation 230, the electronic device may determine whether the simulation to be performed for the first time as part of a third simulation. For example, the electronic device may determine whether the simulation to be performed for the first time as part of the third simulation or a simulation other than the simulation to be performed for the first time in the third simulation and a simulation of the first simulation. For example, the electronic device may determine whether the simulation is the initial iteration within the third simulation, or instead a subsequent instance of the first simulation

When the electronic device determines that the simulation corresponds to a first time simulation in the third simulation, then in operation 240, the electronic device may obtain atomic potential energy by applying the GNN model to receive an initial atomic position as an input. In operation 250, the electronic device may determine the atomic force by using the atomic potential energy. In an embodiment, the electronic device may obtain the atomic potential energy by applying the GNN model to an atomic graph that includes the initial atomic position. In some cases, the atomic graph may be determined by using various known methods, and the methods of determining the atomic graph are not necessarily limited thereto.

When the electronic device determines that the simulation is not being performed for the first time in the third simulation, then in operation 260, the electronic device may update atomic speed by using the atomic force obtained from a previous simulation. In operation 270, the electronic device may update the atomic position by using the updated atomic speed. In operation 280, the electronic device may obtain atomic potential energy by applying the GNN model to the updated atomic position as an input. In operation 290, the electronic device may determine the atomic force based on the atomic potential energy.

FIGS. 3A and 3B are an example of a 3D bucket queue model according to an embodiment.

According to an embodiment, the 3D bucket queue model may include a plurality of buckets divided in a predetermined atomic force space and queues corresponding to respective buckets.

For example, the atomic force space may be include a first atomic force range on a first coordinate axis, a second atomic force range on a second coordinate axis, and a third atomic force range on a third coordinate axis. In an embodiment, the first atomic force range, the second atomic force range, and the third atomic force range may be determined based on actual maximum atomic forces and actual minimum atomic forces on the respective coordinate axes.

In an embodiment, as shown in FIG. 3A, the atomic force space may be represented using the first atomic force range [−m, m] on the X axis, the second atomic force range [−m, m] on the Y axis, and the third atomic force range [−m, m] on the Z axis. However, the example is not necessarily limited thereto. At least one or two of the first atomic force range, the second atomic force range, and the third atomic force range may be different from each other, and the maximum atomic force and the minimum atomic force of at least one of the first atomic force range, the second atomic force range, and the third atomic force range may be different from each other.

In an embodiment, the electronic device may form a plurality of buckets by dividing the first atomic force range into a first plurality of arrays at a first interval (e.g.,

$$\frac{{f}_{max}^{x} - {f}_{min}^{x}}{{N}_{bins}^{x}}$$

of Equation 1 below), dividing the second atomic force range into a second plurality of arrays at a second interval (e.g.,

$$\frac{{f}_{max}^{y} - {f}_{min}^{y}}{{N}_{bins}^{y}}$$

of Equation 1 below), and dividing the third atomic force range into a third plurality of arrays at a third interval (e.g.,

$$\frac{{f}_{max}^{z} - {f}_{min}^{z}}{{N}_{bins}^{z}}$$

of Equation 1 below).

For example, at least two of the first interval, the second interval, and the third interval may be the same or different from each other.

For example, the electronic device may divide the first atomic force range, the second atomic force range, and the third atomic force range through Equation 1 below.

$$[ Equation 1 ]$$

$$\{ \begin{matrix}f\_range {e}_{bx}^{x} = [ {f}_{min}^{x} + ( bx - 1 ) \times \frac{{f}_{max}^{x} - {f}_{min}^{x}}{{N}_{bins}^{x}} , {f}_{min}^{x} + bx \times \frac{{f}_{max}^{x} - {f}_{min}^{x}}{{N}_{bins}^{x}} ) \\ f\_range {e}_{by}^{y} = [ {f}_{min}^{y} + ( by - 1 ) \times \frac{{f}_{max}^{y} - {f}_{min}^{y}}{{N}_{bins}^{y}} , {f}_{min}^{y} + by \times \frac{{f}_{max}^{y} - {f}_{min}^{y}}{{N}_{bins}^{y}} ) \\ f\_range {e}_{bz}^{z} = [ {f}_{min}^{z} + ( bz - 1 ) \times \frac{{f}_{max}^{z} - {f}_{min}^{z}}{{N}_{bins}^{z}} , {f}_{min}^{z} + bz \times \frac{{f}_{max}^{z} - {f}_{min}^{z}}{{N}_{bins}^{z}} )\end{matrix}$$

In Equation 1,

$${f}_{min}^{x}$$

may denote the minimum value of the first atomic force range, and

$${f}_{max}^{x}$$

may denote the maximum value of the first atomic force range. bx may denote an index within an array of the first plurality of arrays, N^{x}_{bins} may denote the total number of arrays in the first plurality of arrays, and

$$f\_range {e}_{bx}^{x}$$

may denote a range of a bx-th array on the X axis.

$${f}_{min}^{y}$$

may denote the minimum value of the second atomic force range, and

$${f}_{max}^{y}$$

may denote the maximum value of the second atomic force range. by may denote an index within an array of the second plurality of arrays, N^{y}_{bins} may denote the total number of arrays in the second plurality of arrays, and

$$f\_range {e}_{by}^{y}$$

may denote a range of a by-th array on the Y axis.

$${f}_{min}^{z}$$

may denote the minimum value of the third atomic force range, and

$${f}_{max}^{z}$$

may denote the maximum value of the third atomic force range. bz may denote an index within an array of the third plurality of arrays,

$${N}_{bins}^{z}$$

may denote the total number of arrays in the third plurality of arrays, and

$$f\_range {e}_{bz}^{z}$$

may denote a range of a bz-th array on the Z axis.

In an embodiment, the electronic device may form the plurality of buckets based on the divided first atomic force range, the divided second atomic force range, and the divided third atomic force range. For example, the electronic device may form a bucket based on at least one of the first plurality of arrays, one of the second plurality of arrays, and one of the third plurality of arrays. For example, a plurality of small rectangular solids of FIG. 3A may represent the plurality of buckets.

According to an embodiment, a queue corresponding to each bucket may include a next bucket associated with a subsequent atomic force that follows the atomic force represented by the current bucket, and a weight indicating a probability that the next bucket is selected.

For example, as shown in FIG. 3B, a queue Q_{A} corresponding to bucket A may include a next bucket associated with a subsequent atomic force that follows the atomic force represented by bucket A, and a weight (e.g., 8, 3, 15, 2, . . . , 1) indicating the probability that the next bucket is selected.

As used herein, a “bucket” refers to a discrete, bounded region within a three-dimensional atomic force space, defined by the intersection of one array from each of the first, second, and third atomic force ranges along the X, Y, and Z axes, respectively. Each bucket may correspond to a specific subrange of atomic force values in all three spatial directions, and may serve as a quantization unit for mapping a continuous atomic force vector to a representative categorical region within the force space.

A “weight” refers to a numerical value associated with a next bucket in a queue, indicating a likelihood or probability that the corresponding next bucket follows a current bucket in the sequence of atomic forces. The set of weights in a given queue may represent a discrete probability distribution over the possible next buckets.

A “queue” refers to a data structure associated with a bucket, where the queue includes one or more entries that each specify a next bucket and a corresponding weight. Each queue may store the previous data or learned data of atomic forces from the current bucket to one or more next buckets. The queue may be used to model the atomic forces in a discrete bucket space and to facilitate efficient prediction of subsequent atomic forces without using the GNN.

FIG. 4A is an example of a process for initializing and updating a 3D bucket queue model, according to an embodiment. FIG. 4B is a flowchart of a process for initializing and updating a 3D bucket queue model, according to an embodiment.

According to an embodiment, after obtaining the result of the third simulation, the electronic device may initialize a 3D bucket queue model based on the result. For example, the electronic device may initialize the 3D bucket queue model by setting a queue and a weight as shown in FIGS. 4A and 4B on two adjacent first-type simulation results within the third simulation.

According to an embodiment, the electronic device may update the 3D bucket queue model each time the electronic device obtains a result from the first simulation. For example, the electronic device may update the 3D bucket queue model by assigning a queue and a weight as shown in FIGS. 4A and 4B on two adjacent results from first-type simulation within the first simulation.

In some embodiments, the electronic device may update the 3D bucket queue model each time the electronic device may perform the first-type simulation of the first simulation. For example, before performing the first-type simulation within the first simulation, the electronic device may back up a previous atomic force obtained through a previous simulation prior to the first-type simulation, and may assign a queue and a weight, as shown in FIGS. 4A and 4B, based on the previous atomic force and a current atomic force obtained from the first-type simulation.

In FIG. 4A,

$${f}_{i ( x , y , z )}^{j - 1}$$

may denote an atomic force vector (e.g., the previous atomic force described below) of an i-th atom obtained by performing a j−1-th simulation (e.g., the previous simulation). The condition i∈[0, n) may be satisfied, where n may denote the total number of atoms.

$${f}_{i ( x , y , z )}^{j}$$

may denote an atomic force vector (e.g., the current atomic force described below) of the i-th atom obtained by performing a j-th simulation (e.g., the current simulation).

The electronic device may associate each atomic force vector

$${f}_{i ( x , y , z )}^{j}$$

with a corresponding previous atomic force vector

$${f}_{i ( x , y , z )}^{j - 1}$$

based on the same atom index i. This correspondence enables the electronic device to identify the temporal progression of atomic force vectors and to update the 3D bucket queue model using the temporal progression.

As shown in FIG. 4B, in operation 410, the electronic device may map the previous atomic force obtained from the previous simulation to a first 3D bucket within the plurality of buckets in the atomic force space. For example, the electronic device may map

$${f}_{i ( x , y , z )}^{j - 1}$$

to the first 3D bucket (e.g., bucket A). In some cases, the previous atomic force may be referred to as the first atomic force.

In an embodiment, the electronic device may determine which bucket of the atomic force space represents a sub-space including a corresponding atomic force, and may map the atomic force to the bucket of the atomic force space.

In an embodiment, the electronic device may determine an index of each atomic force based on a first component corresponding to the first coordinate axis of each atomic force associated with the first array of the first plurality of arrays, a second component corresponding to the second coordinate axis of each atomic force associated with the second array of the second plurality of arrays, and a third component corresponding to the third coordinate axis of each atomic force associated with the third array of the third plurality of arrays, and may map each atomic force to the corresponding bucket based on the index of each atomic force.

For example, the electronic device may determine the index of each atomic force based on the index of the first array to which the first component of each atomic force belongs, the index of the second array to which the second component of each atomic force belongs, and the index of the third array to which the third component of each atomic force belongs.

In an embodiment, the electronic device may map each atomic force to the corresponding bucket through Equation 2 below.

$${bucket}_{bx , by , bz} = \{ \begin{matrix}bx = ⌊ \frac{x - {f}_{min}^{x}}{{f}_{max}^{x} - {f}_{min}^{x}} \times {N}_{bins}^{x} ⌋ \\ by = ⌊ \frac{y - {f}_{min}^{y}}{{f}_{max}^{y} - {f}_{min}^{y}} \times {N}_{bins}^{y} ⌋ \\ bz = ⌊ \frac{z - {f}_{min}^{z}}{{f}_{max}^{z} - {f}_{min}^{z}} \times {N}_{bins}^{z} ⌋\end{matrix} \qquad [ Equation 2 ]$$

In Equation 2, x may denote the first component corresponding to the first coordinate axis of the atomic force, y may denote the second component corresponding to the second coordinate axis of the atomic force, z may denote the third component corresponding to the third coordinate axis of the atomic force, and bucket_{bx,by,bz} may denote an index of a bucket to which the atomic force is mapped.

In operation 420, the electronic device may map the current atomic force obtained from the current simulation to a second 3D bucket of the plurality of buckets within the atomic force space. For example, the electronic device may map

$${f}_{i ( x , y , z )}^{j}$$

(e.g., through Equation 2 above) to the second 3D bucket (e.g., bucket B). In some cases, the current atomic force may be referred to as the second atomic force.

In operation 430, the electronic device may determine whether the second 3D bucket is included in the queue of the first 3D bucket. When the second 3D bucket is included in the queue of the first 3D bucket, then in operation 440, the electronic device may increase a weight of the second 3D bucket by a first value (e.g., 1). the second 3D bucket is not included in the queue of the first 3D bucket, then in operation 450, the electronic device may add the second 3D bucket to the queue of the first 3D bucket and may set a weight of the second 3D bucket to a default value.

For example, as shown in FIG. 4A, when bucket B is included in the queue Q_{A} of bucket A, the electronic device may increase the weight of bucket B, weight B, in the queue Q_{A}. When bucket B is not included in the queue Q_{A} of bucket A, the electronic device may add bucket B to the queue Q_{A} and may set the weight B of bucket B to the default value (e.g., 1). In some embodiments, the electronic device may add the bucket B to the queue by insertion order, sorted by weight, or arranged in a priority-based structure based on implementation requirements.

Before performing the simulation using the 3D bucket queue model, the electronic device may enhance the of simulations performed with the 3D bucket queue model by initializing the 3D bucket queue model based on a result of the third simulation.

Initializing the 3D bucket queue model using the result of the third simulation may enable the electronic device to generate the queues and associated weights with transition data derived from a high-fidelity GNN model. The initialized state of the 3D bucket queue model may reflect realistic force dynamics and spatial distributions, enabling the 3D bucket queue model to make predictions of atomic forces with improved accuracy.

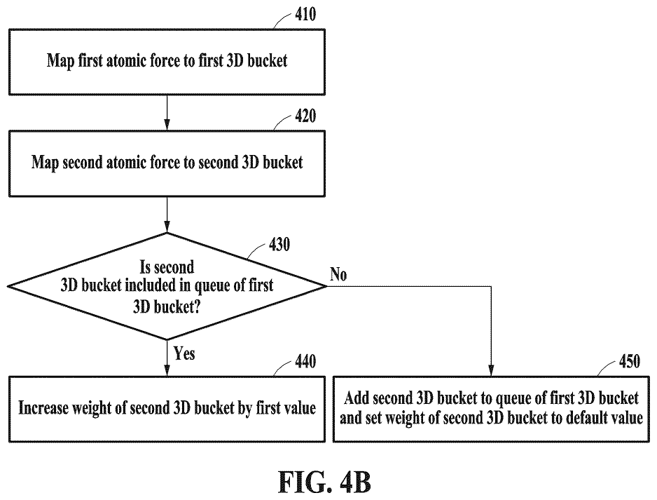

FIG. 5 is a flowchart of a process for performing a simulation of a second type, according to an embodiment.

As shown in FIG. 5, in operation 510, the electronic device may map a previous atomic force (or a first atomic force) obtained through a previous simulation before performing a simulation of a second type (or a second simulation), to a third 3D bucket from among a plurality of buckets. For example, the electronic device may determine an index of the first atomic force (e.g., through Equation 2 above) and may determine the third 3D bucket based on the index of the first atomic force.

In an embodiment, when the simulation performed before the simulation of the second-type is a simulation of the first type, the electronic device may predict the atomic force based on the result of the simulation of the first type using the 3D bucket queue model. When the simulation performed before the simulation of the second type is also the simulation of the second type, the electronic device may predict the atomic force based on the result of the previous second type simulation using the 3D bucket queue model.

In operation 520, the electronic device may obtain a bucket having the maximum weight in the queue of the third 3D bucket. For example, when the bucket having the maximum weight is bucket A as FIG. 3B, the electronic device may obtain and identify the entry of the bucket having a weight of 15 in the queue of bucket A.

In operation 530, the electronic device may generate a predicted atomic force based on the bucket having the maximum weight. For example, the electronic device may determine one (e.g., an arbitrary atomic force) of atomic forces corresponding to the bucket having the maximum weight as the predicted atomic force.

In some embodiments, the queue of the third 3D bucket may store references to one or more other buckets associated with one or more representative atomic forces derived from prior simulations. The electronic device may select a predicted atomic force by retrieving a representative value from the bucket associated with the maximum weight, such as a previously sampled force vector or an averaged force vector of the predetermined force range of the bucket.

The prediction process using the 3D bucket queue model enables the electronic device to bypass real-time inference using the GNN model, thereby reducing computational cost and improving simulation speed. In some aspects, the queue-based model provides accurate approximations after initialization and updates through repeated first-type simulations. The second-type simulation may be alternated with the first-type simulation in an iterative framework, enabling results from the first-type simulation to update and reinforce the queue structure, thereby enhancing the quality of subsequent second-type predictions.

FIG. 6 is a flowchart of a method for predicting an atomic force, according to an embodiment. The method may coordinate alternating executions of first-type and second-type simulations, along with initialization and updating of a 3D bucket queue model, to iteratively enhance the atomic force prediction accuracy.

As shown in FIG. 6, in operation 610, an electronic device may initialize hyperparameters by setting variables i, j, k, and s to a default value (e.g., 1). These variables may serve as iteration counters for different stages of the simulation process. For example, the variable i may be used for initial first-type simulations used for initialization, j for first-type simulations used for updating, k for second-type simulations, and s for the number of alternating update cycles performed.

In operation 620, the electronic device may perform a simulation of the first type and may increase the variable i by 1. The simulation of the first type (or the first simulation) may involve applying a GNN model to obtain atomic forces based on current atomic positions. These atomic forces may be stored for model initialization in subsequent operations.

In operation 630, the electronic device may determine whether the variable i is greater than or equal to a third threshold value i0.

When the variable i is less than the third threshold value i0, the electronic device may repeat operation 620 until the condition is satisfied.

When the variable i is greater than or equal to the third number i0, the electronic device may initialize a 3D queue model in operation 640. In operation 640, the electronic device may initialize the 3D queue model. Initialization may be performed using atomic force transition data derived from the results of the first-type simulations, as described with reference to FIGS. 4A and 4B. This operation generates the bucket queues with entries representing force-to-force transitions, along with associated weights.

In operation 650, the electronic device may perform the simulation of the first type and may increase the variable j by 1. In some cases, this first-type simulation may be performed based on the GNN model, and the results may be used to incrementally refine the previously initialized 3D bucket queue model through online updates.

In operation 660, the electronic device may determine whether the variable j is greater than or equal to a first threshold value j0. The first threshold value j0 may represent a threshold for the number of first-type simulations used in the refinement phase, prior to alternating with second-type simulations.

When the variable j is less than the first threshold value j0, the electronic device may repeat operation 650 until the update threshold is met.

When the variable j is greater than or equal to the first threshold value j0, the electronic device may update the 3D queue model in operation 670. However, the example is not necessarily limited thereto, and the electronic device may update the 3D queue model immediately after operation 650. For example, the electronic device may update the 3D queue model after performing the simulation of the first type and increasing the variable j by 1.

For example, the electronic device may store a previous atomic force (e.g., a first atomic force) obtained through a previous simulation (e.g., a first simulation) before performing the simulation of the first type, map the previous atomic force to the first 3D bucket, map an atomic force obtained by performing the simulation of the first type in operation 650 to update the second 3D bucket, determine whether the second 3D bucket is included in the queue of the first 3D bucket, increase a weight of the second 3D bucket by a first value when the second 3D bucket is included in the queue of the first 3D bucket, add the second 3D bucket to the queue of the first 3D bucket when the second 3D bucket is not included in the queue of the first 3D bucket, and set the weight of the second 3D bucket to the default value.

In operation 680, the electronic device may perform a simulation of the second type (e.g., a second simulation) to generate a predicted atomic force using the updated 3D bucket queue model, thereby avoiding the computationally intensive GNN model. The device may increase the variables k and s by 1. In some aspects, k represents the count of second-type simulations performed in the current cycle, and s tracks the number of completed simulation cycles involving alternating first-type and second-type simulations.

In operation 690, the electronic device may determine whether the variable k is greater than or equal to a second threshold value k0. The second threshold value k0 represents the target number of second-type simulations to be performed within one cycle before another first-type simulation is initiated to update the 3D bucket queue model.

When the variable k is less than the second threshold value k0, the electronic device may repeat operation 680 until the condition is satisfied.

When the variable k is greater than or equal to the second threshold value k0, the electronic device may determine whether the variable s is greater than a predetermined threshold value s0 in operation 691. In some cases, the threshold value s0 represents the maximum number of simulation cycles and serves as a stopping condition for the iterative process.

When the variable s is less than the predetermined threshold value s0, the electronic device may set the variables j and k to the default value in operation 692 and may repeat operation 650 until the condition is satisfied. Resetting the counters j and k allows the device to restart a new cycle of first-type and second-type simulations. In an embodiment, operation 692 may further include updating the first threshold value j0 and the second threshold value k0. In some cases, updating first threshold value j0 and second threshold value k0 enables accuracy and optimized resource usage

When the variable s is greater than or equal to the predetermined threshold value s0, the electronic device may terminate the simulation. This indicates that the total number of alternating cycles of first-type and second-type simulations has reached a predefined threshold. For example, a simulation termination condition may be that the execution number of simulations of the second type reaches a predetermined threshold value. However, the example is not necessarily limited thereto, and the simulation termination condition may be other suitable conditions (e.g., the sum of all simulation counts reaches the threshold value, the execution time of simulations of the first type reaches the threshold value, etc.).

In an embodiment, operations 620 and 630 may correspond to the third simulation, operations 650 and 660 may correspond to the first simulation, and operations 680 and 690 may correspond to the second simulation. FIG. 6 illustrates how the iterative control structure supports the simulation method by initialization with the third simulation, refinement based on the first simulation using the GNN, and efficient prediction using the second simulation and the 3D bucket queue model.

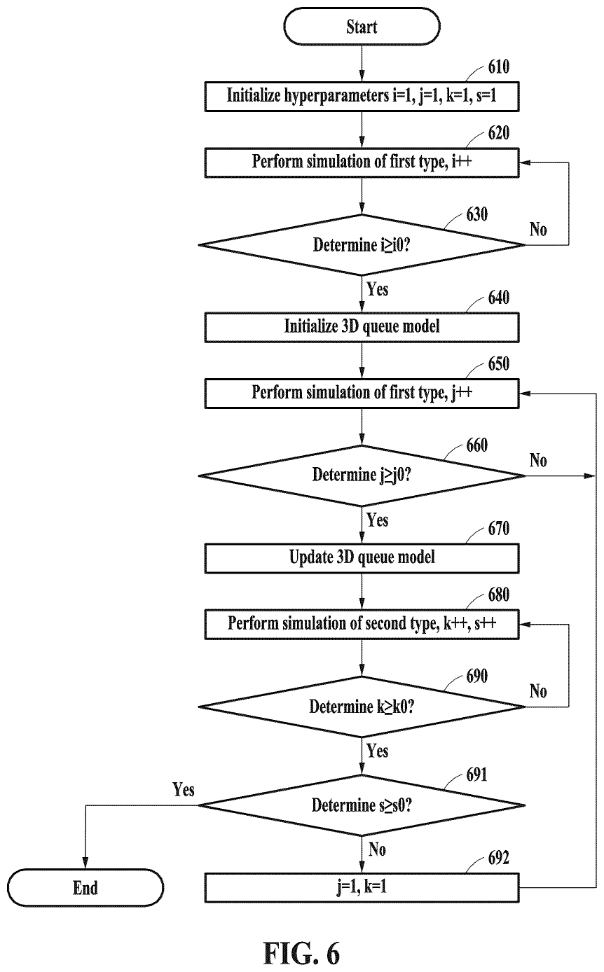

FIG. 7 is a block diagram of an electronic device according to an embodiment.

An electronic device 710 may include, for example, a desktop computer, a laptop, a tablet computer, a server system, and a supercomputer. However, the electronic device 710 is not necessarily limited thereto, and the electronic device 710 may include any device capable of performing atomic force prediction based on graph neural networks and queue-based modeling. For example, the electronic device 710 may perform (e.g., perform the method of predicting an atomic force) a large-scale analysis.

As shown in FIG. 7, the electronic device 710 may include a first simulation module 711, an update module 712, and a second simulation module 713. These modules may be implemented using a circuit, hardware, software executed by one or more processors, or a combination thereof. In some cases, each module may correspond to an operation in the simulation process described in FIG. 6.

In an embodiment, the first simulation module 711 may execute the first simulation based on a GNN model. In some cases, the first simulation module 711 may receive atomic positions or atomic graph data as input, process the input using a GNN (or a trained GNN), and generate atomic force vectors or potential energies. The output may be used for training, updating, or initializing the 3D bucket queue model.

According to an embodiment, the first simulation may include obtaining a first number of atomic forces for each atom by performing a first predetermined number of simulations of a first type. The process of performing the simulation of the first type is described with reference to FIG. 2.

In an embodiment, the update module 712 may update a 3D bucket queue model based on a result obtained from the first simulation. The process of updating the 3D bucket queue model is described with reference to FIGS. 4A and 4B.

In an embodiment, the second simulation module 713 may execute the second simulation based on the updated 3D bucket queue model. In some cases, the second simulation module 713 may retrieve previously stored atomic forces, map the stored atomic forces to buckets, and generate predictions using the 3D bucket queue model.

According to an embodiment, the second simulation may include obtaining a second number of atomic forces for each atom by executing the second predetermined number of simulations of a second type. The process of executing the simulation of the second type is described with reference to FIG. 5.

According to an embodiment, the electronic device 710 may iteratively perform the first simulation and the second simulation until a count of simulations of the second type reaches a predetermined threshold value. This iterative process enables continuous refinement of the 3D bucket queue model and balances prediction accuracy with computational efficiency.

In an embodiment, the first simulation module 711 may perform the third simulation based on the GNN model before initially executing the first simulation. For example, the third simulation serves to generate an initial set of atomic force transitions for initializing the 3D bucket queue model.

According to an embodiment, the third simulation may include obtaining a third number of atomic forces by performing the third predetermined number of simulations of the first type.

In an embodiment, the electronic device 710 may further include an initialization module. The initialization module may initialize the 3D bucket queue model based on a result obtained from the third simulation. In some cases, initialization may include generating queues with initial transitions and assigning weights based on observed/experimented forces.

In an embodiment, the initialization module and the update module 712 may be implemented as a single module.

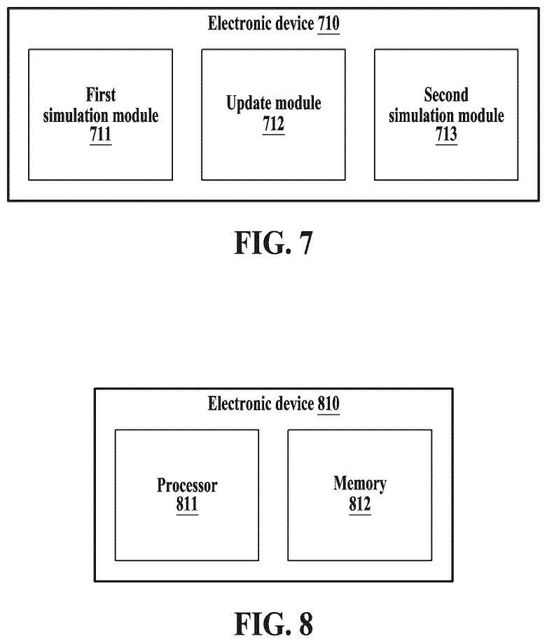

FIG. 8 is a block diagram of an electronic device according to an embodiment.

An electronic device 810 may include a desktop computer, a laptop, a tablet computer, a server system, and a supercomputer, similar to the electronic device 710 of FIG. 7, but the example is not necessarily limited thereto. For example, the electronic device 810 may perform (e.g., predicting an atomic force) a large-scale analysis.

In an embodiment, the electronic device 810 may include a processor 811 and a memory 812. The processor 811 may perform the operations (e.g., detailed operations of predicting an atomic force described with reference to FIG. 6) of the modules (e.g., the first simulation module 711, the update module 712, the second simulation module 713) described with respect to FIG. 7. The memory 812 may store one or more instructions. When executed by the processor 811, the one or more instructions stored in the memory 812 may cause the electronic device 810 to predict an atomic force. For example, the one or more instructions stored in the memory 812, when executed by the processor 811, may cause the electronic device 810 to perform the first simulation based on the GNN model, update the 3D bucket queue model based on the result obtained from the first simulation, and perform the second simulation based on the updated 3D bucket queue model. The one or more instructions stored in the memory 812, when executed by the processor 811, may cause the electronic device 810 to perform the third simulation based on the GNN model before performing the first simulation and initialize the 3D bucket queue model based on the result obtained from the third simulation.

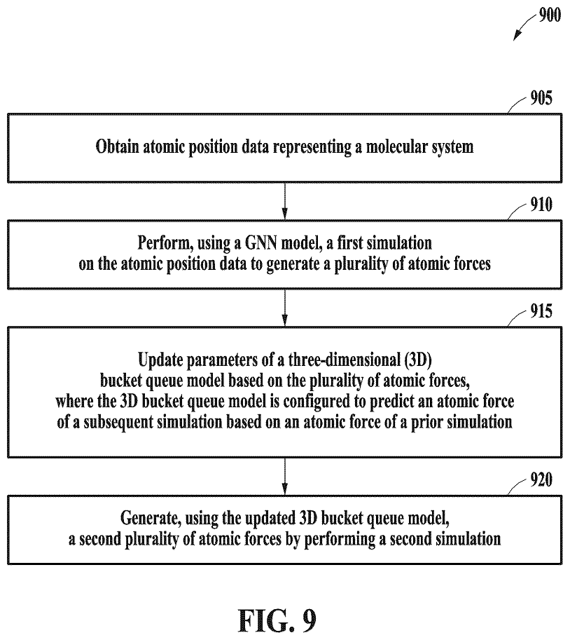

FIG. 9 is a flowchart of a method 900 for predicting an atomic force, according to an embodiment. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the electronic device obtains atomic position data representing a molecular system. The atomic position data may describe the spatial coordinates of atoms at an initial simulation state.

At operation 910, the electronic device may perform a first simulation, using a GNN model, on the atomic position data to generate a plurality of atomic forces. For example, the GNN model may receive atomic graphs obtained from the atomic position data and compute potential energy values, from which atomic forces are determined.

At operation 915, the electronic device may update parameters of a three-dimensional (3D) bucket queue model based on the plurality of atomic forces obtained from the first simulation. The 3D bucket queue model is configured to predict an atomic force of a subsequent simulation based on an atomic force of a prior simulation. In some aspects, the 3D bucket queue model may include a plurality of buckets and corresponding queues indicating probabilistic transitions between atomic force states.

At operation 920, the electronic device may generate a second plurality of atomic forces by performing a second simulation using the updated 3D bucket queue model. The second simulation predicts atomic forces based on the observed force transitions stored in the 3D bucket queue model, thereby reducing computational reliance on the GNN model.

The described device, unit, module, and other components may be implemented by hardware components. The examples of hardware components used for performing the described operations may include a controller, a sensor, a generator, a driver, a memory, a comparator, an arithmetic logic unit, an adder, a subtractor, a multiplier, a divider, an integrator, and any other electronic components configured to perform the described operations. In an example, one or more hardware components for performing the described operation may be implemented by computing hardware (e.g., one or more processors or a computer). A processor or computer may be implemented by one or more processing devices (e.g., a logic gate array, a controller, an arithmetic logic unit, a digital signal processor, a microcomputer, a programmable logic controller, a field programmable gate array, a programmable logic array, a microprocessor, any other devices configured to respond to and execute an instruction in a defined manner to achieve a desired result, or a combination of devices). In an embodiment, the processor or computer may include one or more memories storing an instruction or software executed by the processor or computer or may be connected thereto. A hardware computer implemented by the processor or computer may execute an instruction or software (e.g., an operating system (OS) or one or more software applications executed on the OS to perform the described operation. The hardware component may access, manipulate, process, generate, or store data in response to the execution of the instruction or software.

As described herein, the description of a “processor” or “computer” is used as singular, but in some examples, a plurality of processors or computers may be used, or the processor or computer may include multiple processing elements, multiple types of processing elements, or both. For example, a single hardware component or two or more hardware components may be implemented by a single processor, two or more processors, or a processor and a controller. The one or more hardware components may be implemented by one or more processors or a processor and a controller, and one or more other hardware components may be implemented by one or more other processors or another processor and another controller. The one or more processors or the processor and the controller may implement a single hardware component or two or more hardware components. The hardware component may have one or more different processing configurations, and an example of various processing configurations may include a single processor, an independent processor, a parallel processor, single instruction single data (SISD) multiprocessing, single instruction multiple data (SIMD) multiprocessing, multiple instruction single data (MISD) multiprocessing, and multiple instruction multiple data (MIMD) multiprocessing.

The method for performing the described operation may be performed using computing hardware (e.g., one or more processors or computers), and the computing hardware may be implemented to execute the instruction or software as described above to perform a task executed by the described method. For example, a single task or two or more tasks may be performed by a single processor, two or more processors, or a processor and a controller. The one or more operations may be performed by one or more processors or a processor and a controller, and one or more other operations may be performed by one or more other processors or another processor and another controller. The one or more processors or the processor and the controller may perform a single task or two or more tasks.

The instruction or software implementing the hardware component by controlling the processor or computer and performing the method and relevant data, a data file, and a data structure may be recorded, stored, or fixed to one or more non-transitory computer-readable storage media. The examples of the non-transitory computer-readable storage media may include read-only memory (ROM), programmable ROM (PROM), electrically erasable PROM (EEPROM), random access memory (RAM), dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid state drive (SSD), card memory (e.g., a multimedia card, a secure digital (SD) card, or an extreme digital (XD) card), magnetic tape, floppy disk, a magneto-optical data storage device, an optical data storage device, and other digital storage devices. In some cases, an additional device may be configured to store the instruction, software, relevant data, the data file, or the data structure in a non-transitory manner and provide the instruction, software, relevant data, the data file, or the data structure to the processor or computer to execute the instruction.

While the embodiments are illustrated and described in detail, one of ordinary skill in the art should understand that various modifications of the form and details are possible without departing from the spirit and scope recited by the claims.

What is claimed is:

1. A method, performed using an electronic device, for predicting an atomic force, the method comprising:
obtaining atomic position data representing a molecular system;
performing, using a graph neural network (GNN) model, a first simulation on the atomic position data to generate a plurality of atomic forces;
updating parameters of a three-dimensional (3D) bucket queue model based on the plurality of atomic forces, wherein the 3D bucket queue model is configured to predict an atomic force of a subsequent simulation based on an atomic force of a prior simulation; and
generating, using the updated 3D bucket queue model, a second plurality of atomic forces by performing a second simulation,
wherein the first simulation comprises:
obtaining a first number of atomic forces for each atom by performing the first simulation for a first predetermined number of repetitions of a first type, and
the second simulation comprises:
obtaining a second number of atomic forces for each atom by performing the second simulation for a second predetermined number of repetitions of a second type.

2. The method of claim 1, further comprising:
iteratively performing the first simulation and the second simulation until a number of repetitions of the second type reaches a predetermined threshold value.

3. The method of claim 2, further comprising:
iteratively performing the first simulation and the second simulation when at least one of the first predetermined number of repetitions or the second predetermined number of repetitions is changed.

4. The method of claim 1, further comprising:
performing, using the GNN model, a third simulation to obtain a preliminary result; and
initializing the 3D bucket queue model based on the preliminary result;
wherein the third simulation comprises:
obtaining a third number of atomic forces for each atom by performing the third simulation for a third predetermined number of repetitions of the first type.

5. The method of claim 4, wherein performing the third simulation comprises:
when a simulation of the first type is performed for the first time within the third simulation:
generating, using the GNN model, atomic potential energy based on an initial atomic position of the atomic position data; and
generating an atomic force based on the atomic potential energy;
when a simulation of the first type is not performed for the first time within the third simulation:
updating an atomic speed based on an atomic force from the prior simulation;
updating an atomic position based on the updated atomic speed;
generating, using the GNN model, atomic potential energy based on the updated atomic position; and
generating an atomic force based on the atomic potential energy.

6. The method of claim 1, wherein:
the 3D bucket queue model includes a plurality of buckets divided within a predetermined atomic force space and a plurality of queues corresponding to the plurality of buckets, respectively,
wherein the atomic force space includes a first atomic force range on a first coordinate axis, a second atomic force range on a second coordinate axis, and a third atomic force range on a third coordinate axis,
wherein the plurality of buckets is generated by dividing the first atomic force range into a first plurality of arrays at a first interval, dividing the second atomic force range into a second plurality of arrays at a second interval, and dividing the third atomic force range into a third plurality of arrays at a third interval, and
wherein a queue corresponding to each bucket includes a subsequent bucket to which a subsequent atomic force following an atomic force corresponding to the bucket, and includes a weight indicating a probability of an appearance of the subsequent bucket.

7. The method of claim 6, wherein updating parameters of the 3D bucket queue model comprises:
for each of the first predetermined number of repetitions of the first type:
storing a previous atomic force obtained from a previous simulation before performing the simulation of the first type and mapping the previous atomic force to a first 3D bucket within the plurality of buckets;
mapping an atomic force from the simulation of the first type to a second 3D bucket within the plurality of buckets;
determining whether the second 3D bucket is included in a queue of the first 3D bucket;
increasing a weight of the second 3D bucket by a first value when the second 3D bucket is included in the queue of the first 3D bucket, and
adding the second 3D bucket to the queue of the first 3D bucket and setting the weight of the second 3D bucket to a default value.

8. The method of claim 7, wherein performing the simulation of the second type comprises:
for each of the second predetermined number of repetitions of the second type:
mapping a previous atomic force from a previous simulation, before performing the simulation of the second type, to a third 3D bucket within the plurality of buckets;
obtaining a bucket having a maximum weight in a queue of the third 3D bucket; and
generating a predicted atomic force based on the bucket having the maximum weight.

9. The method of claim 8, wherein mapping the previous atomic force comprises:
determining an index of the previous atomic force based on a first component corresponding to a first coordinate axis of the previous atomic force from a first array of the first plurality of arrays, a second component corresponding to a second coordinate axis of the previous atomic force from a second array of the second plurality of arrays, and a third component corresponding to a third coordinate axis of the previous atomic force from a third array of the third plurality of arrays; and
determining the third 3D bucket based on the index of the previous atomic force.

10. The method of claim 8, wherein:
the predicted atomic force includes the bucket having the maximum weight.

11. A non-transitory computer-readable storage medium storing one or more instructions,
wherein the one or more instructions, when executed by a processor, cause the processor to:
obtain atomic position data representing a molecular system;
perform, using a graph neural network (GNN) model, a first simulation on the atomic position data to generate a plurality of atomic forces;
update parameters of a three-dimensional (3D) bucket queue model based on the plurality of atomic forces, wherein the 3D bucket queue model is configured to predict an atomic force of a subsequent simulation based on an atomic force of a prior simulation; and
generate, using the updated 3D bucket queue model, a second plurality of atomic forces by performing a second simulation.

12. An electronic device comprising:
a processor; and
a memory storing one or more instructions,
wherein the one or more instructions, when executed by the processor, cause the electronic device to:
obtain atomic position data representing a molecular system;
perform, using a graph neural network (GNN) model, a first simulation on the atomic position data to generate a plurality of atomic forces,
update parameters of a three-dimensional (3D) bucket queue based on the plurality of atomic forces, and
generate, using the updated 3D bucket queue model, a second plurality of atomic forces by performing a second simulation,
obtain a first number of atomic forces for each atom performing the first simulation for a first predetermined number of repetitions of a first type, and
obtain a second number of atomic forces for each atom by performing the second simulation for a second predetermined number of repetitions of a second type,
wherein the 3D bucket queue model is configured to predict an atomic force of a subsequent simulation based on an atomic force of a prior simulation.

13. The electronic device of claim 12, wherein the one or more instructions, when executed by the processor, cause the electronic device to:
iteratively perform the first simulation and the second simulation until a number of repetitions of the second type reaches a predetermined threshold value.

14. The electronic device of claim 13, wherein the one or more instructions, when executed by the processor, cause the electronic device to:
iteratively perform the second simulation when at least one of the first predetermined number of repetitions or the second predetermined number of repetitions is changed.

15. The electronic device of claim 12, wherein the one or more instructions, when executed by the processor, cause the electronic device to:
perform, using the GNN model, a third simulation to obtain a preliminary result,
initialize the 3D bucket queue model based on the preliminary result, and
obtain a third number of atomic forces for each atom by performing the third simulation for a third predetermined number of repetitions of the first type.

16. The electronic device of claim 15, wherein the one or more instructions, when executed by the processor, cause the electronic device to:
when a simulation of the first type is performed for the first time within the third simulation:
generate, using the GNN model, atomic potential energy based on an initial atomic position of the atomic position data, and
generate an atomic force based on the atomic potential energy,
when a simulation of the first type is not performed for the first time within the third simulation:
update an atomic speed based on an atomic force from the prior simulation,
update an atomic position based on the updated atomic speed,
generate, using the GNN model, atomic potential energy based on the updated atomic position, and
generate an atomic force based on the atomic potential energy.

17. The electronic device of claim 12, wherein:
the 3D bucket queue model includes a plurality of buckets divided within a predetermined atomic force space and a plurality of queues corresponding to the plurality of buckets, respectively,
wherein the atomic force space includes a first atomic force range on a first coordinate axis, a second atomic force range on a second coordinate axis, and a third atomic force range on a third coordinate axis,
wherein the plurality of buckets is generated by dividing the first atomic force range into a first plurality of arrays at a first interval, dividing the second atomic force range into a second plurality of arrays at a second interval, and dividing the third atomic force range into a third plurality of arrays at a third interval, and
wherein a queue corresponding to each bucket includes a subsequent bucket to which a subsequent atomic force following an atomic force corresponding to the bucket, and includes a weight indicating a probability of an appearance of the subsequent bucket.

18. The electronic device of claim 17, wherein the one or more instructions, when executed by the processor, cause the electronic device to:
for each of the first predetermined number of repetitions of the first type:
store a previous atomic force obtained from a previous simulation before performing the simulation of the first type and map the previous atomic force to a first 3D bucket within the plurality of buckets,
map an atomic force from the simulation of the first type to a second 3D bucket within the plurality of buckets,
determine whether the second 3D bucket is included in a queue of the first 3D bucket,
increase a weight of the second 3D bucket by a first value when the second 3D bucket is included in the queue of the first 3D bucket, and
add the second 3D bucket to the queue of the first 3D bucket and set the weight of the second 3D bucket to a default value when the second 3D bucket is not included in the queue of the first 3D bucket.

19. The electronic device of claim 18, wherein the one or more instructions, when executed by the processor, cause the electronic device to:
for each of the second predetermined number of repetitions of the second type:
map a previous atomic force from a previous simulation before performing the simulation of the second type, to a third 3D bucket within the plurality of buckets,
obtain a bucket having a maximum weight in a queue of the third 3D bucket, and
generate a predicted atomic force based on the bucket having the maximum weight.

20. The electronic device of claim 19, wherein the one or more instructions, when executed by the processor, cause the electronic device to:
determine an index of the previous atomic force based on a first component corresponding to a first coordinate axis of the previous atomic force from a first array of the first plurality of arrays, a second component corresponding to a second coordinate axis of the previous atomic force from a second array of the second plurality of arrays, and a third component corresponding to a third coordinate axis of the previous atomic force from a third array of the third plurality of arrays, and
determine the third 3D bucket based on the index of the previous atomic force.
